(19) United States
(12) Patent Application Publication
(10) Pub. No.: US 2012/0178054 A1
(43) Pub. Date: Jul. 12, 2012

(54) METHOD AND ARRANGEMENT OF A FLIGHT SIMULATOR SYSTEM

(75) Inventors: Magnus Jomander, Ljungsbro (SE); Jörgen Nilsson, Linkoping (SE); Göran Nordqvist, Linkoping (SE)

(73) Assignee: SAAB AB, Linkoping (SE)

(21) Appl. No.: 13/378,767

(22) PCT Filed: Jun. 16, 2009
(86) PCT No.: PCT/SE2009/050744

§ 371 Date: Mar. 27, 2012

(51) Int. Cl. G09B 9/08

(52) U.S. Cl. 434/38

(57) ABSTRACT

A method and an image generator in a flight simulator system for generating a simulated head mounted display. The simulated head mounted display area represents a display area in a head mounted display and is positioned in a visual surrounding in dependence of a signal representing a position of a head of a pilot.

### TECHNICAL FIELD

The present invention relates to a method and a device in a flight simulator system, and in particular to a method and an image generator for simulating a HMD, Head Mounted Display.

### BACKGROUND

Flight simulator systems, are often used to train pilots of aircrafts. Typically in such simulators a pilot views a simulated outside environment scene (“visual environment”) projected onto a screen by an image projector.

In a real aircraft, a HMD, Head Mounted Display, may be provided on the pilot's helmet on to which information about targets is projected in front of the pilot's eyes. The pilot looks through the HMD at an outside environment, and the HMD keeps symbology information about targets collimated and superposed from the pilot's viewpoint over the associated targets outside the aircraft.

A HMD can also be used in a flight simulator system to simulate a real aircraft in which the pilot uses a HMD. Using a HMD in a flight simulator is however associated with many problems. For instance individual calibration of the HMD is required for each user of the flight simulator system. Calibrations that are required are for instance focal distance, IPD, Inter Pupillary Distance, Exit Pupil, Eye Relief, head size and distance to the visual environment. It is also complicated to attach the HMD to the user's head. HMD's are also expensive.

There is therefore a need for a solution for providing an improved flight simulator system that can simulate an aircraft system in which the pilot is using a HMD.

### SUMMARY

An object of the present invention is thus to provide an improved flight simulator system requiring less setting and maintenance, which is able to simulate a real aircraft system in which the pilot uses a HMD.

This object is achieved according to the present invention by generating a simulated HMD area where the HMD area represents a display area in a HMD and positioning the simulated HMD area in a visual surrounding.

A first aspect of the present invention relates to an image generator for use in a flight simulator system displaying a visual surrounding. The image generator comprising: receiving means for receiving a first signal indicating a position of a pilot's head. The image generator being characterized in that it further comprises: means for generating a simulated HMD, Head Mounted Display, area where the simulated HMD area represents a display area in a HMD; means for positioning the simulated HMD area in the visual surrounding in dependence of the first signal.

A second aspect of the present invention relates to a method for an image generator for use in a flight simulator system displaying a visual surrounding. The method comprises the steps of: receiving a first signal indicating a position of a pilot's head; generating a simulated HMD, Head Mounted Display, area where the simulated HMD area represents a display area in a HMD; positioning the simulated HMD area in the visual surrounding in dependence of the first signal.

Exemplary embodiments of the present invention also relates to a flight simulator system comprising the image generator.

An advantage with embodiments of the present invention is that the present invention requires fewer setting like for instance focal distance, Inter Pupillary Distance (IPD), Exit Pupil, Eye Relief and head size. The maintenance is therefore cheaper and the availability higher.

Yet a further advantage with embodiments of the present invention is good correlation between the simulated HMD area and HMD target symbols.

A further advantage with embodiments of the present invention is that it is not required to measure a position of the pilot's head. It is only necessary to measure an angular position of the pilot's head

### BRIEF DESCRIPTION OF THE DRAWINGS

The invention will in the following be described in more detail with reference to enclosed drawings, wherein:

FIG. 1 schematically illustrates an aircraft system according to prior art.

FIG. 2 schematically illustrates a flight simulator system according to prior art.

FIG. 3 schematically illustrates a flight simulator system according to exemplary embodiments of the present invention.

FIG. 4 is a flowchart of a method according to exemplary embodiments of the present invention.

### DETAILED DESCRIPTION

In the following description, for purposes of explanation and not limitation, specific details are set forth, such as particular sequences of steps, signalling protocols and device configurations in order to provide a thorough understanding of the present invention. It will be apparent to the one skilled in the art that the present invention may be carried out in other embodiments that depart from these specific details.

Moreover, those skilled in the art will appreciate that functions and means explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as a system comprising a computer processor and a memory coupled to the processor, wherein the memory is encoded with one or more programs that may perform the functions disclosed herein.

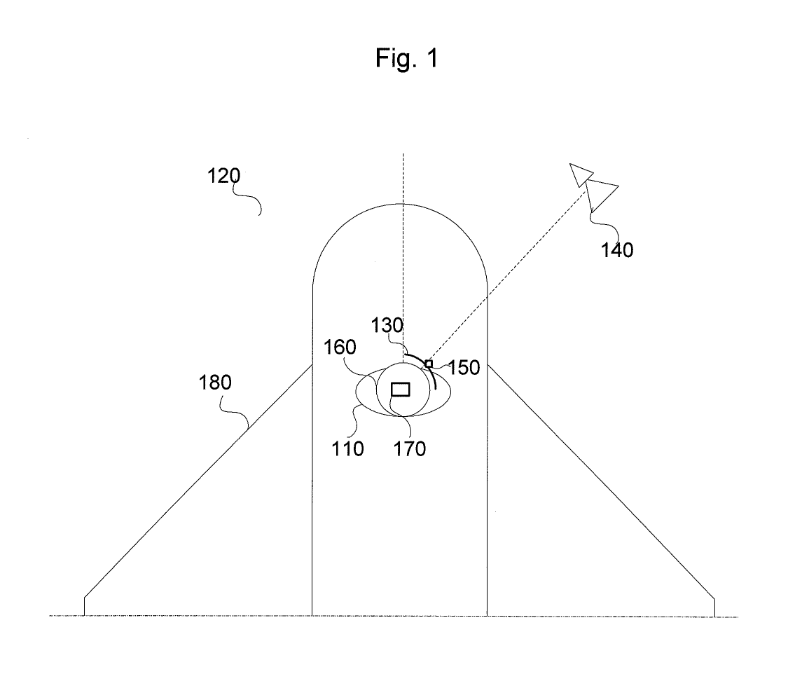

FIG. 1 schematically illustrates a real aircraft system 120 in which a pilot 110 is using a HMD 130. The HMD 130 may sometimes also be referred to as Helmet Mounted Sight and Display (HMSD) or Helmet Mounted Sights (HMS). As mentioned above, information about targets 140 outside the aircraft 180 are projected onto the HMD 130. The pilot 110 looks through the HMD 130 at an outside environment. The aircraft system 120 keeps symbol information 150 about targets 140 on the HMD 130 collimated and superposed from the pilots viewpoint over the associated targets 140 outside the aircraft 180. In order for the aircraft system 120 to display the symbol information 150 in the correct place at the HMD 130 head tracking means 170 is provided on the pilot's head 160. The head tracking means 170 detects the pilot's head movements and signals to the aircraft system 120 in which direction the pilot 110 is looking. When the pilot 110 turns his head 160 the symbol information 150 moves on the HMD 130 so that the symbol information 150 always is collimated and superposed no matter in which direction the pilot 110 is looking.

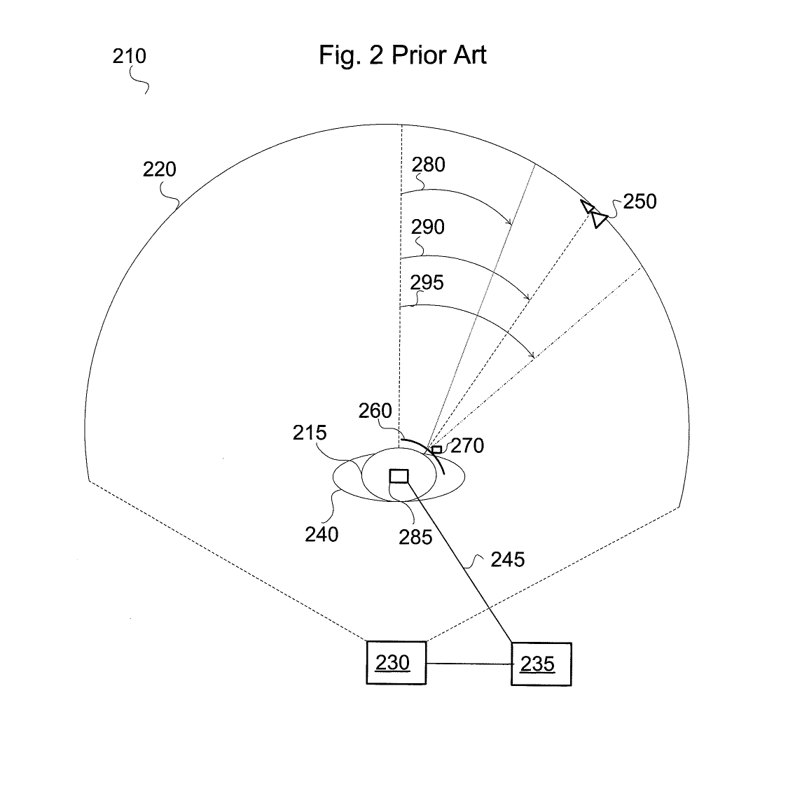

FIG. 2 schematically illustrates a flight simulator system 210 designed to simulate the aircraft system 120 of FIG. 1. The flight simulator system 210 may comprise a dome 220 on to which a visual surrounding (not shown) is projected by a projector 230. A pilot 240 of the flight simulator system 210 is positioned the dome 220 so that the pilot 240 can see the visual surrounding when looking around. In a simulation scenario the visual surrounding may for instance show targets 250. As can be seen in FIG. 2 the pilot 240 is wearing a HMD 260 on to which symbol information 270 about targets 250 is projected. The symbol information 270 is collimated and superposed from the pilot's 240 viewpoint over the associated target 250 shown on the visual surrounding. In the flight simulator system 210 a head tracker 285 is mounted on the pilot's head 215 in order to keep track of a position of the pilot's head. A signal 245 from the head tracker 285 is transferred to a control unit 235 of the flight simulator system 210. The control unit 235 displays the symbol information 270 in the correct position on the HMD using the signal 245. When the pilot 240 moves his/her head 215 the symbol information 270 should also move on the HMD 260 in order for the symbol information 270 to always be collimated and superposed from the pilot's viewpoint over the associated targets 250 projected on the visual surrounding.

One problem associated with using a HMD in the flight simulator system 210 is that an error in the measurement of the pilot's head position will result in that symbol information will not be aligned with the target 250 displayed on the visual surrounding. Consider a scenario were the pilot 240 is turning his head 215 a first angle 290. If the head tracker 280 measures that the pilot 240 has moved his head 215 a second angle 280 different form the first angle 290, the head tracker has not correctly detected the pilot's head movement. This means that the symbol information 270 will be displayed in a wrong position 295 on the HMD 260. As can be seen in FIG. 2 the symbol information 270 is displayed on a right side of the target 250 instead of superposed with the target 250.

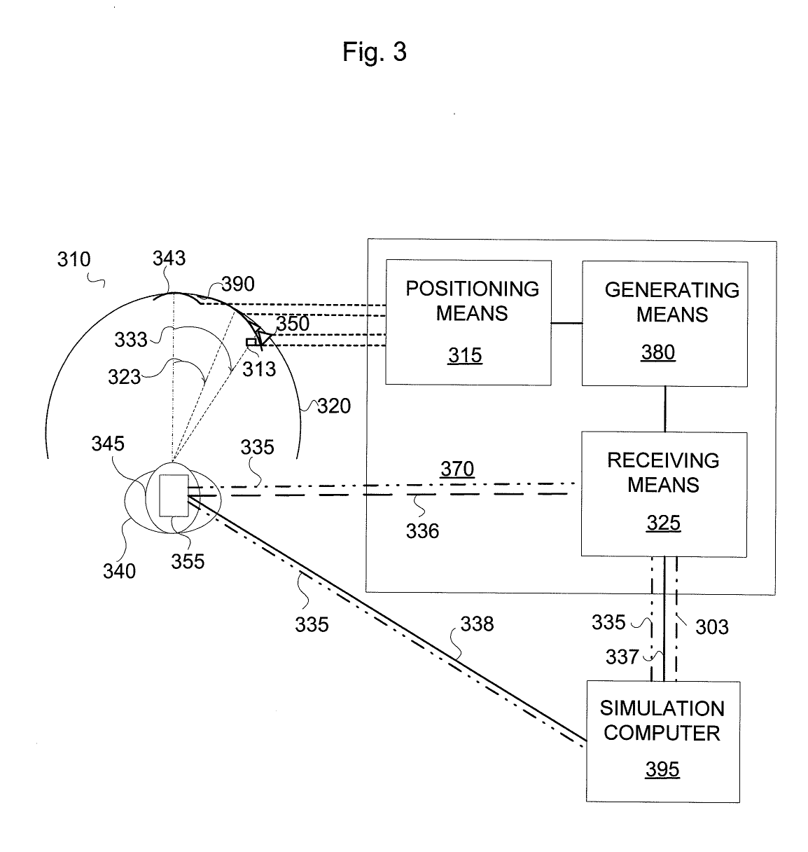

FIG. 3 schematically illustrates a flight simulator system 310 according to exemplary embodiments of the present invention. The flight simulator system 310 is designed to simulate an aircraft system in which the pilot is using a HMD. The flight simulator system 310 comprises a dome 320 onto which a visual surrounding (not shown) is displayed. A pilot 340 of the flight simulator system 310 is positioned in the dome 320 so that the pilot 340 can see the visual surrounding when looking around. In a simulation scenario the visual surrounding may for instance show targets 350. As can be seen in FIG. 3 the pilot 340 is not wearing a HMD. Instead the flight simulator system 310 comprises an image generator 370 comprising means 380 for generating a simulated HMD area 390, where the simulated HMD area 390 represents a display area in a HMD. The flight simulator system 310 further comprises a head tracker unit 355 mounted on the pilot's head 345. A signal 335 indicating the position of the pilot's head is generated by the head tracker unit 355. The signal 335 preferably comprises a pitch angle, a yaw angle and a roll angle for the pilot's head. The image generator 370 further comprises receiving means 325 for receiving the signal 335 indicating a position of the pilot's head 345. With the positioning means 315 in the image generator 370 the simulated HMD area 390 is positioned in the visual surrounding in dependence of the signal 335.

According to exemplary embodiments of the present invention the head tracker unit 355 is connected via a connection 336 to the receiving means 325. The signal 335 is then received in the image generator 370 directly from the head tracker unit 355. An advantage with receiving the signal 335 directly from the head tracker unit 355 via the connection 336 is that it may provide for faster generation and positioning of the simulated HMD area 390.

The flight simulator system also comprises a flight simulation computer 395. The flight simulator computer 395 is connected to the head tracker unit via a connection 338. The flight simulation computer 395 thus receives the signal 335 indicating the position of the pilot's head 345 form the head tracker unit 355.

According to other exemplary embodiments of the present invention the image generator 370 receives the signal 335 from the simulation computer 395 via a connection 337. The receiving means 325 in the image generator can thus receive the signal 335 from the head tracker unit 355 or from the simulation computer 395.

According to yet other exemplary embodiments of the present invention target symbols 313 are displayed on the simulated HMD area 390. In these exemplary embodiments the receiving means 325 also receives a second signal 303 from the simulation computer 395 indicating a position for the target symbol 313. The second signal 303 is received from the simulation computer 395 via the connection 337. The position for the target symbol 313 is determined in the simulation computer 395 in dependence on the first signal 335 received from the head tracker unit 355 via the connection 338. The simulation computer 395 may for instance also use radar information (not shown) when determining the position for the target symbol 313. The position for the target symbol 313 is determined so that the target symbol 313 is collimated and superposed from the pilot's 340 viewpoint over the associated target 350 shown on the visual surrounding. When the pilot 340 moves the head 345 the target symbol 313 also should move on the simulated HMD area 390 in order for the target symbol 313 to always be collimated and superposed from the pilot's 340 viewpoint over the associated target 350 projected on the visual surrounding.

Thus, according to exemplary embodiments, the signal 335 is used both for positioning the simulated HMD area 390 and for determining the second signal 303, which is used for positioning the target symbol 313. An advantage achieved with this solution is that an error in measurement of the pilot's head position will be cancelled out. This since the signal 335 both influences the position for the simulated HMD area 390 and the target symbol 313.

Consider a scenario were the pilot 340 is turning his head 345 a first angle 333. If the head tracker unit 355 measures that the pilot 340 has turned his head 345 a second angle 323 different from the first angle 333, the head tracker unit 355 has not correctly detected the pilot's head movement. This will however not result in that the symbol information 313 will be displayed in a wrong position on the virtual HMD area 390. This since the signal 335 both influences the position for the simulated HMD area and the target symbol 313. As can be seen in FIG. 3 the target symbol 313 is displayed superposed with the target 350.

According to yet other exemplary embodiments of the image generator 370 the generating means 380 is further configured for generating a simulated HUD, Head Up Display, area 343 where the simulated HUD area 343 represents a display area in a HUD. In these exemplary embodiments the means 315 for positioning is further configured for positioning the simulated HUD area 343 in the visual surrounding.

An advantage when using the simulated HUD area 343 together with the simulated HMD area 390 compared to using a real HMD is that it is not necessary to measure the position of the pilot's head 345. It is only necessary to measure the angular position of the pilot's head. With a real HMD and HUD it is also necessary to take into account that the pilot can move his head sideways. When the pilot for instance moves his head sideways a parallax error may arise between the HMD, HUD and the visual surrounding.

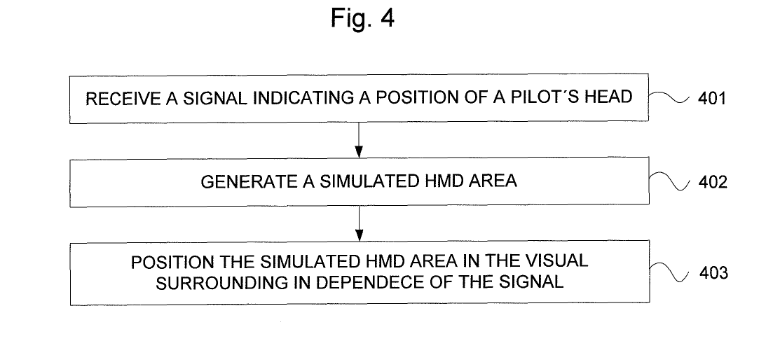

Referring to FIG. 4 there is illustrated a flowchart of a method describing the steps for positioning the simulated HMD area 390, in accordance with previously described embodiments of the present invention. As shown in FIG. 4, the method comprises:

(401) receiving a first signal indicating a position of a pilot's head;

(402) generating a simulated HMD, Head Mounted Display, area, where the simulated HMD area represents a display area in a HMD;

(403) positioning the simulated HMD area in the visual surrounding in dependence of the first signal.

While the present invention has been described with respect to particular embodiments (including certain device arrangements and certain orders of steps within various methods), those skilled in the art will recognize that the present invention is not limited to the specific embodiments described and illustrated herein. Therefore, it is to be understood that this disclosure is only illustrative. Accordingly, it is intended that the invention be limited only by the scope of the claims appended hereto.

1. An image generator (370) for use in a flight simulator system (310) displaying a visual surrounding, comprising: receiving means (325) for receiving a first signal (335) indicating a position of a pilot's head (345), said image generator (370) being characterized in that it further comprises: means (380) for generating a simulated HMD, Head Mounted Display, area (390) where said simulated HMD area (390) represents a display area in a HMD; and means (315) for positioning said simulated HMD area (390) in said visual surrounding in dependence of said first signal (335).

2. An image generator (370) according to claim 1, where said receiving means (325) are further configured for receiving a second signal (303) indicating a position for a target symbol (313), and where said means (315) for positioning are further configured for positioning said target symbol (313) in said simulated HMD area (390) in dependence on said second signal (303).

3. An image generator (370) according to claim 1 or 2, where said means for generating (380) are further configured for generating a simulated HUD, Head Up Display, area (343) where said simulated HUD area (343) represents a display area in a HUD, and where said means (315) for positioning are further configured for positioning said simulated HUD area (343) in said visual surrounding.

4. A flight simulator system comprising the image generator (370) according to any of claims 1 to 3, said flight simulator system further comprising a head tracker unit (355) for generating said first signal (335); where said head tracker unit (355) is connected via a connection (336) to said receiving means (325).

5. A flight simulator system comprising the image generator (370) according to any of claims 1 to 3, said flight simulator system further comprising a head tracker unit (355) for generating said first signal (335); and a simulation computer (395) connected to said receiving means (325) via a connection (337), where said head tracker unit (355) is connected to said simulation computer (395) via a connection (338).

6. A flight simulator system according to claim 5, where said head tracker unit (355) is connected to said receiving means (325) via a connection (336).

7. A flight simulator system according to any of claims 5 to 6, where said simulation computer (395) is further configured for determining a second signal (303) indicating a position for a target symbol (313) in dependence on said first signal (335); said receiving means (325) are further configured for receiving said second signal (303), and where said means (315) for positioning are further configured for positioning said target symbol (313) in said simulated HMD area (390) in dependence on said second signal (303).

8. A method for an image generator (370) for use in a flight simulator system (310) displaying a visual surrounding, the method comprising the steps of:
receiving (401) a first signal (335) indicating a position of a pilot's head (345); said method being characterized in that it comprises the further steps of:
generating (402) a simulated HMD, Head Mounted Display, area (390) where said simulated HMD area (390) represents a display area in a HMD; and
positioning (403) said simulated HMD area (390) in said visual surrounding in dependence of said first signal (335).

9. The method according to claim 8 wherein said first signal (335) is received from a head tracker unit (355) in said flight simulator system (310).

10. The method according to claim 8 wherein said first signal (335) is received from a simulation computer (395) in said flight simulator system (310).

11. The method according to any of claims 8 to 10, wherein said method comprises the further steps of:
receiving a second signal (303) indicating a position for a target symbol (313), where said position for said target symbol (313) is determined in dependence on said first signal (335); and
positioning said target symbol (313) in said simulated HMD area (390) in dependence on said second signal (303).

12. The method according to any of claims 8 to 11, where said method comprises the further steps of:
generating a simulated HUD, Head Up Display, area (343) where said simulated HUD area (343) represents a display area in a HUD, and
positioning said simulated HUD area (343) in said visual surrounding.
